(19) United States
(12) Patent Application Publication
(10) Pub. No.: US 2007/0144247 A1
(43) Pub. Date: Jun. 28, 2007

(54) Multiple function stable sensor circuitry

(76) Inventor: Peter H. Seesink, Ouddorp (NL)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/317,771

(22) Filed: Dec. 23, 2005

(51) Int. Cl. B60C 23/02; G01M 17/02; G01L 19/04

(52) U.S. Cl. 73/146.3; 73/146; 73/708

(57) ABSTRACT

Multiple function stable circuitry measures both pressure and temperature for example. It includes both a pressure sensitive capacitor, and fixed reference capacitor, and also includes both a constant current source and a temperature variable current source. The complete cycle includes at least two phases, with one phase of the cycle utilizing one reference capacitor and one pressure variable capacitor; and at least one other phase including the reference capacitor and at least one temperature variable charging source. Other multiple slope multiple functions may also be implemented.

### FIELD

This invention relates to sensing systems, such as pressure and/or temperature sensing systems.

### BACKGROUND

In the field of pressure sensors, it is known to provide a diaphragm type variable capacitor, in which the capacitance varies with applied pressure. A fixed reference capacitor is also provided, and pressure is determined by circuitry which compares the capacitance of the variable capacitor and the reference capacitor. Two representative patents disclosing this type of system are U.S. Pat. Nos. 4,398,426 and 6,199,575.

For applications such as automobile or truck tire pressure sensors, it would be useful to also measure the temperature. However, it is relatively costly to provide both a pressure sensor and a temperature sensor.

### SUMMARY

In accordance with the present invention both pressure and temperature may be measured using a single circuit which is significantly less expensive than the cost of separate pressure and temperature sensing systems.

In accordance with one sensing system illustrating the principles of the invention, a reference capacitor and a pressure variable capacitor are provided; and both a constant reference charging current source and a temperature varying charging current source are also provided. Initially the reference capacitor is charged to a predetermined reference voltage level from the constant current source, and then the system is switched so that the pressure variable capacitor is charged by the same constant reference current until a reference voltage is reached. The same sequence is then followed using the temperature variable current source. Comparator circuits are provided for indicating when the capacitors are charged to the reference levels.

The time for each of these charging intervals are indicative of both the pressure and the temperature. The output may be in the form of pulse width modulated signals, or digital signals, or may initially be in one form and converted to the other. Digital control and counter circuits, including a source of clock pulse signals may be employed to count the time periods for each interval included in the sequences set forth above. The counting circuitry can include well known circuitry which counts the number of clock pulses which occur between specified events and hence measures the time interval between those events.

The pressure is determined by the ratio of the time for charging the pressure variable capacitor to the time required for charging the reference capacitor. This output may be provided either digitally, or as a pulse width modulated signal, or both.

Further, the temperature is determined by comparing the time for the cycle using the temperature varying charging current source, with the time for the cycle using the fixed current charging source.

In the implementation of the foregoing, a single reference capacitor, a single pressure variable capacitor, a single integrator, and a single set of comparator circuits are used for both pressure and temperature calculations, thereby providing both pressure and temperature output signals which is significantly less expensive than separate circuits for determining pressure and temperature, separately.

In accordance with another feature of the illustrative system, the charging interval may involve charging (and discharging) from an initial starting voltage point to a different reference level and then back to the starting point. In the present specification and claims the phrase “charging or supplying current until a predetermined voltage level is reached”, encompasses the “down-up” or “up-down” charging as well as charging in one polarity only, either up or down.

One advantage of the system for measuring both pressure and temperature is the low cost and relative simplicity of the system as compared with providing two separate circuits for measuring temperature and pressure. Thus, as noted above, many of the circuit elements, such as the integrator, the comparators, the microprocessor and other circuit components may be employed for both the pressure and the temperature sensing.

Other objects, features and advantages of the invention will become apparent from a consideration of the following detailed description, and from the associated drawings.

### BRIEF DESCRIPTION OF THE DRAWINGS

The invention may be more readily understood by referring to the accompanying drawings in which:

FIG. 1 is a schematic showing of a system illustrating an application of the invention;

FIG. 2 shows a semiconductor chip which may be employed in the implementation of the invention.

FIG. 3 is a circuit diagram illustrating the principles of the invention;

FIG. 4 shows waveforms illustrating the mode of operation of FIG. 3;

FIG. 5 is a program flow diagram indicating the program steps employed in analyzing the output signals involving the circuitry of FIGS. 1, 3 and 4; and

FIG. 6 indicates one possible way of utilizing pulse width modulation signals, or converting them to another format.

Like numerals refer to like parts throughout the several views of the drawings.

### DETAILED DESCRIPTION

While the specification describes particular embodiments of the present invention, those of ordinary skill can devise variations of the present invention without departing from the inventive concepts.

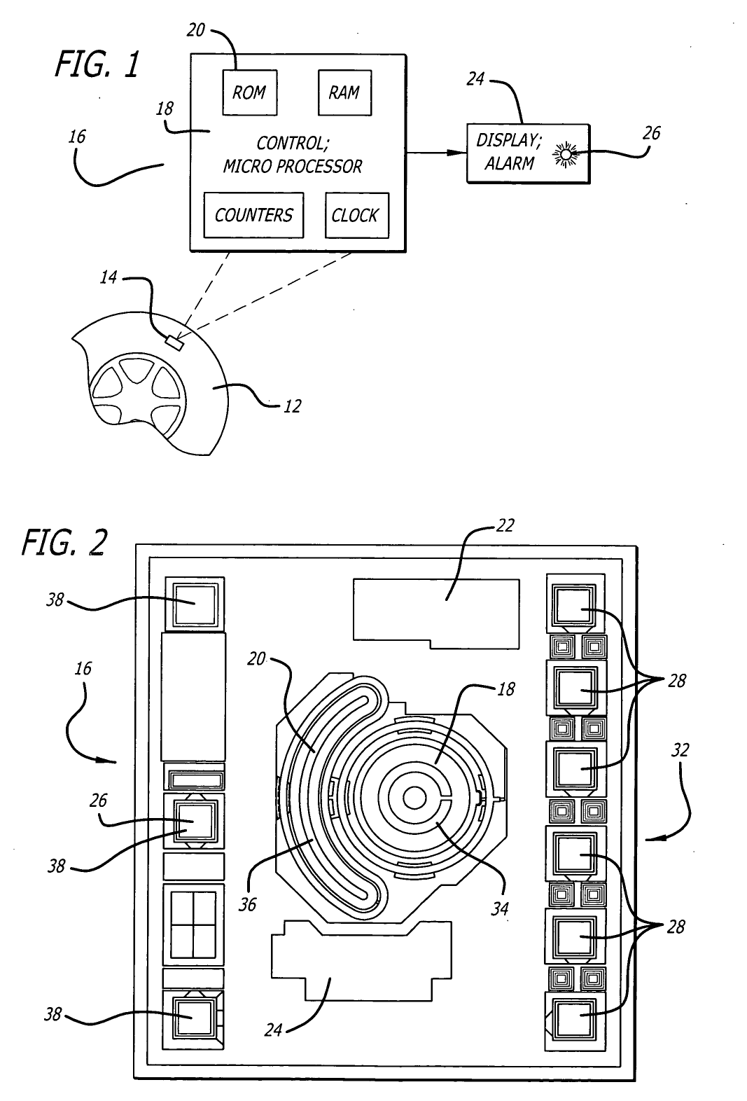

Referring now to FIG. 1 of the drawings, an automobile or a truck tire 12 is provided with a sensor chip 14 which is exposed to the air contained within the tire 12. The sensor chip 14 is coupled to the microprocessor 16 mounted in the vehicle by radio frequency or other known arrangements. The microprocessor 16 includes a data processing and control section 18 including counters, a Read Only Memory or ROM 20 and a Random Access Memory or RAM 22. A display and alarm circuit 24 provides a visual output displaying pressure and temperature along with an alarm signal 26 to indicate pressure or temperature levels exceeding predetermined limits.

The ROM 20 contains a program for calculating the pressure and temperature from the signals provided from the sensor chip 14, as developed in detail in connection with FIGS. 1-4 of the drawings.

FIG. 2 of the drawings is a semiconductor chip 32 included in the sensor 14 of FIG. 1.

The semiconductor chip includes a variable capacitance diaphragm 34, which deflects with applied pressure, changing the spacing between electrodes to vary the capacitance. The symbol Cₚ indicating capacitance varying with pressure will be employed in parts of the following specification. Also visible in FIG. 2 are the fixed reference capacitor 36 and output coupling pads 38.

The chip 32 and its associated variable and reference capacitors 34 and 36 are described in greater detail in U.S. patent application Ser. No. 10/872,055, filed Jun. 18, 2004, and assigned to the assignee of this invention and application. The foregoing patent application is hereby incorporated by reference into this specification.

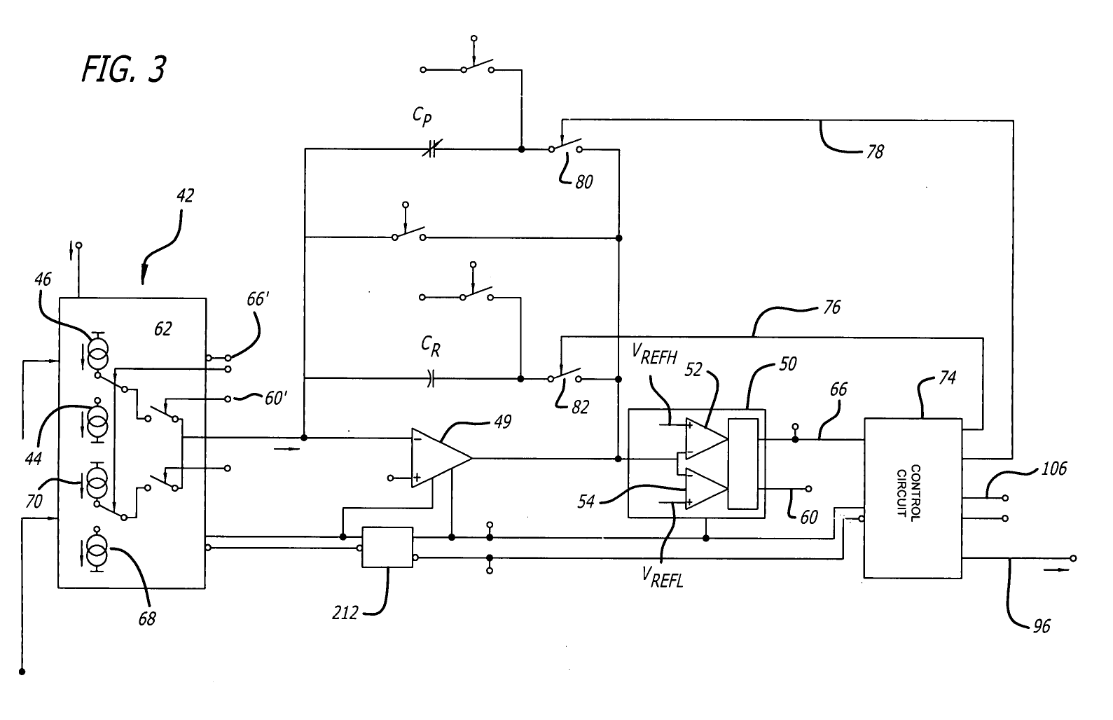

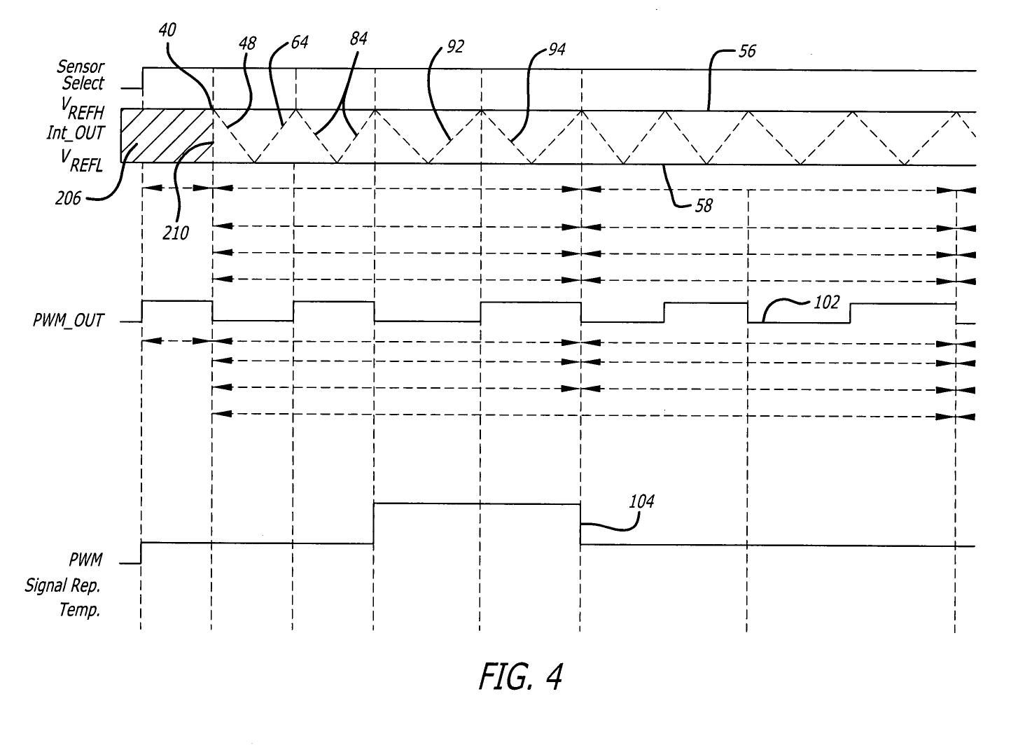

Consideration will now be given to the circuit of FIG. 3 and the companion plots of FIG. 4 which show the various electrical wave forms present in the circuit of FIG. 3.

Initially, it may be noted that capacitors Cₚ and C_{R} are shown somewhat to the left of center in FIG. 3. These two capacitors are initially charged to a predetermined reference voltage level as indicated at point 40 in FIG. 4. The biasing, or charging/discharging circuit 42 includes source 44 of reference current I_{REF} for charging the two capacitors C_{R} and Cₚ;

and also includes a companion source 46 of current I_{REF} for discharging the two capacitors.

The first step in the cycle is to linearly discharge the reference capacitor, as indicated at reference numeral 48 in FIG. 4 of the drawings with the discharging bias current source 46 being coupled to C_{R}. Parenthetically, the variable capacitor Cₚ is not being actively charged or discharged at this time.

The integrator 49 senses the I_{REF} discharge current, and provides an output equal to the voltage level on reference capacitor C_{R}. The comparator circuit 50 includes comparator 52 which has two inputs, one being from integrator 49 and the other being a high reference input voltage V_{REFH}. A second comparator 54 has as one input the output from integrator 49, and has a low reference voltage V_{REFL} applied to its other input. The high and the low reference voltage levels correspond to the voltage levels 56 and 58 as shown in the plots of FIG. 4.

When the reference capacitor C_{R} is discharged to the lower reference level 58, as detected by comparator 54, it provides an output switching signal on lead 60. This switching signal is connected to the bias or charging/discharging circuit 42 (see reference numeral 60′) and switches the reference current from discharge source 46 to the charge reference current source 44 by the actuation of switching circuitry 62. The reference capacitor is then linearly charged back up to the high reference level 56 as indicated at reference numeral 64 in FIG. 4.

When the reference capacitor C_{R} is charged back up to the high reference level indicated at 56 in FIG. 4, the comparator 52 provides an output signal on lead 66.

The signal on lead 66 is applied to the control circuit 74, and output signals are applied on circuits 76 and 78 to operate switches 80 and 82, to disconnect the reference capacitor C_{R} from the circuit, and to switch in the pressure variable capacitor Cₚ. With capacitor Cₚ in the circuit, and starting charged from the high reference voltage level 56 (see FIG. 4), the same sequence of discharging Cₚ and then applying current to charge it up to the high voltage level (see level 56 in FIG. 4) takes place. This is indicated by the V-shaped characteristic 84 as shown in FIG. 4.

Upon completion of this second sequence, a second “up” signal is provided on lead 66. This is connected to the bias or charge/discharge circuit 42 at lead 66′; with the result of switching to the temperature varying charge and discharge current sources 68 and 70 (with circuits 44 and 46 being temporarily inactive).

The cycle of first discharging and then charging the reference capacitor CR, and then charging and discharging the variable capacitor Cₚ is then accomplished, as indicated by the V-shaped plots at reference numerals 92 and 94 in FIG. 4.

In the previous section of the specification, the detailed mode of operation of the circuit of FIG. 3 has been set forth. We will now consider the surprising results which have been achieved. Specifically, as will be detailed below, both temperature and pressure information is available from the operation of the circuit, while using much of the circuit of FIG. 3 for obtaining both pressure and temperature information. This is of course much simpler and less expensive than having two complete circuits, one for measuring pressure and the other for measuring temperature.

First, considering pressure information, the control circuit 74 includes at least one bistable circuit connected to output lead 78. This bistable circuit is responsive to “up” signals applied to control circuit 74, to change state as indicted by the pulse width modulated plot shown at reference numeral 102 in FIG. 4. The bistable circuit is set to its low output state whenever the reference capacitor C_{R} is being discharged and charged; and

is set to its high output state when the variable capacitor Cₚ is being charged or discharged.

It is particularly to be noted that the mode of operation set forth in the preceding paragraph occurs both when the basic reference current sources 44 and 46 are active, and also when the temperature varying current sources 68 and 70 are being employed. In each case, the ratio of the time for charging (and discharging) the variable capacitor Cₚ to the time for charging the reference capacitor C_{R}, provides the pressure information. In this regard, it may be noted that this ratio will be the same whether the reference current sources 44, 46, or the temperature sensitive current sources 68, 70 are used. Of course, to determine the actual pressure from the pulse width modulated signals, offset and slope factors must be employed.

Concerning the temperature determination, the ratio of the complete cycle using the temperature sensitive current sources 68, 70 to the complete cycle using the reference current sources 44, 46 is indicative of the temperature. An additional bistable circuit included in control circuit 74 provides a second pulse width modulated signal shown at 104 in FIG. 4 on output lead 106 from control circuit 74.

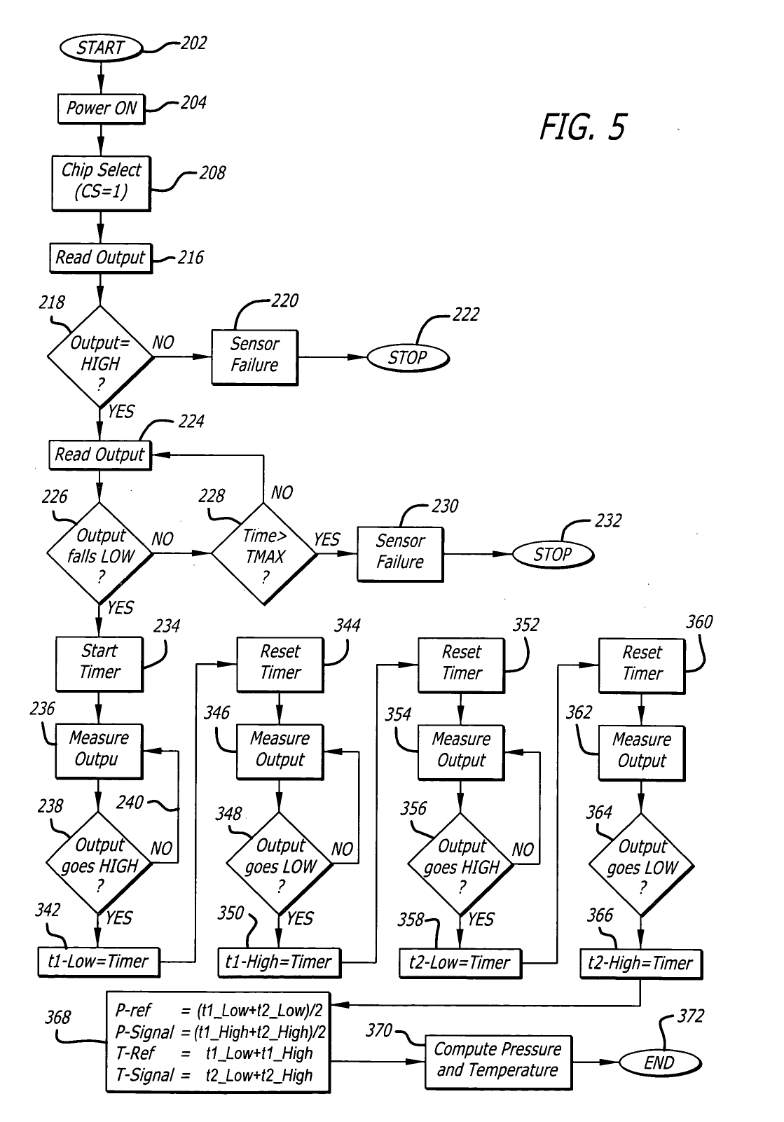

Consideration will now be given to the program flow diagram of FIG. 5 as associated with the electrical wave forms of FIG. 4. Initially, the start of the program is indicated at reference numeral 202 and the “Power-On” block 204 starts the initialization interval 206 (see FIG. 4). The cycles described hereinabove are then enabled by the “chip select” or “sensor select” signal 208, see wave form 208′ in FIG. 4. Following initialization, a control voltage shifts from a positive voltage level to a low or ground voltage level 58 as indicated at reference numeral 210 in FIG. 4. During the initialization interval the two capacitors C_{R} and Cₚ are set to the desired (high) reference voltage level, and the other circuits are to their initial states. The charge mode select block 212 (see FIG. 3) is set to use the current source 44; and the triangular wave form of FIG. 4 starting at point 40 begins.

The signal 66 to the control circuit 74 is read periodically, as indicated by block 216 in FIG. 5. During the initialization interval, the output voltage should be high and block 218 indicates an inquiry as to the state of the control input to control circuit 74, during initialization. If the output is not high (NO), sensor blocks 220 and 222 indicate a malfunction and the program is aborted. If the output is HIGH indicated by “YES” at the output of block 218, the program proceeds to block 224. If the output remains high, indicated by a “NO” answer to the block 226 inquiry, the program recycles through timing diamond 228 to block 224. However, if the control signal remains high beyond an established time period, a sensor failure is indicated and the program aborts, as indicated at blocks 230 and 232. However, a “YES” indication indicates normal initiation of the cycle, and the program continues to program step 234, corresponding to the cycle initiation point 40 in FIG. 4.

The next few blocks of the program follow the saw tooth wave form 48, 64, 84, etc., shown in FIG. 4. Specifically, block 236 indicates reading the output from comparator 52 on lead 66 to the control circuit 74. Program step 238 inquires “Output goes high?” to see if the charging cycle has increased the voltage from one of the capacitors C_{R} or Cₚ to the reference level V_{REFH} at the input to comparator 52 (level 56 on FIG. 4), causing an output on lead 66. The program recirculates as indicated by line 240 until the output on lead 66 of FIG. 5 goes high, and then proceeds to program step 342. This completes the initial timing cycle using C_{R} and switches pressure variable capacitor Cₚ into the charging and discharging cycle.

Program steps 344, 346, 348 and 350 complete the saw tooth wave charging (and discharging) cycle using capacitor Cₚ and the reference current. During the interval from block 234 through 342, the pulse width modulated output remains low but during the second cycle, using capacitor Cₚ the pulse width modulated pressure signal on plot 102 (FIG. 4) remains high, as indicated by the legend in block 350.

Following program step 350, the circuit of FIG. 3 (1) switches over to a temperature variable charging current and (2) switches C_{R} back into the circuit, and during this portion of the cycle the PWM signal is low. The program steps 352, 354, 356 and 358 implement this cycle. Finally, still using the temperature varying charging current, the program steps 360, 362, 364 and 366 complete one cycle of pressure and temperature signal measurement. The PWM signal continues to be low when the reference capacitor C_{R} is employed but high when the capacitor Cₚ is used.

The ratio of the high square wave pulses to the low intervals between pulses is indicative of the pressure.

Further, the ratio of (1) the longer time intervals during which the temperature variable charging current is employed to (2) the total time period of the cycle using the reference charging circuit, is indicative of the temperature.

In each case the offset and slope of the function permits ready calculation of the pressure and the temperature from these timed intervals, as indicated by the program steps.

These last program steps are indicated by program steps 368 and 370. Of course, in the usual case the program steps 226-370 will be repeated continuously prior to the final program step 372.

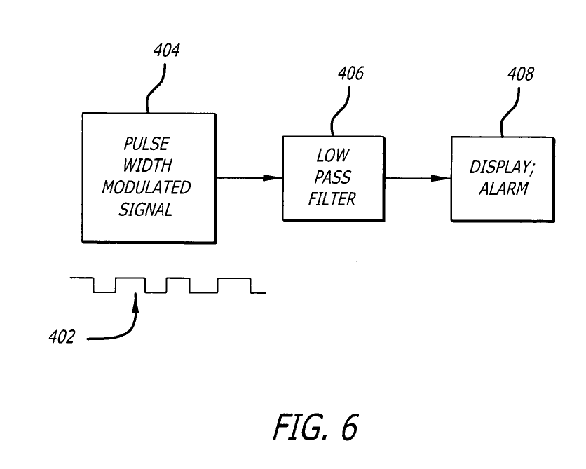

Referring now to FIG. 6 of the drawings, pulse width modulated signals 402 are supplied from circuitry 404 to the low pass filters 406. The low pass filter circuit 406 has changed the pulse width modulated signals from low pass filter 406 into a slowly varying D.C. signal. This maybe accomplished by selecting the filter components, such as the capacitance and resistance of an R-C filter circuit so that the time constant of the filter is very low, thus eliminating the pulse configuration. Analog display and Alarm circuitry 408 is then coupled to the low pass filter.

As will be appreciated, various modifications can be made without departing from the scope or spirit of the invention. For example, the order in which the temperature and pressure parameters is measured is not critical, and the methodology of the present invention could be applied to sensing other parameters.

What is claimed is:

1. A multiple function multiplex, sensor system comprising:
a reference capacitor;
a pressure sensitive variable capacitor;
a reference current source;
a current source for supplying current which is variable with temperature;
circuitry for applying current to said reference capacitor from said reference current source until a predetermined reference voltage is reached;
circuitry for applying current to said pressure sensitive capacitor from said reference current source until a predetermined reference voltage is reached;
circuitry for alternately supplying current to said capacitors using the reference current source and using the temperature variable current source;
circuitry for determining a first ratio between the time for charging the pressure variable capacitor, and the time for charging the reference capacitor, to provide an indication of the applied pressure; and
said system including circuitry for determining a second ratio of (1) the time required for charging both the reference and pressure variable capacitors using the temperature variable current source, and (2) the time required for charging both capacitors using the reference current source.

2. A multiple function, multiplex, multislope sensor system as defined in claim 1 wherein said circuitry for applying current cycles from a starting voltage level to a different level and then back to the starting level.

3. A sensor system as defined in claim 1 wherein said counting circuitry determines the number of clock pulses for charging both the reference capacitor and for charging the pressure variable capacitor using the temperature variable current source.

4. A multiple function, multiplex system as defined in claim 1 including circuitry for providing an output pulse width modulated signal representing pressure.

5. A multiple function, multiplex system as defined in claim 1 including circuitry for providing an output pulse width modulated signal representing temperature.

6. A multiple function, multiplex system as defined in claim 1 including circuitry for providing a pulse width modulated signal representing both pressure and temperature.

7. A multiple function, multiplex system as defined in claim 1 wherein said system includes switching circuitry, and comparator circuits for sensing the voltage level state of the capacitors, and actuating the switching circuitry to change mode when said reference voltage is reached.

8. A multiple function, multiplex system as defined in claim 1 wherein an integrator is coupled to receive current corresponding to the charging current to provide voltage level signals to said comparators.

9. A multiple function multiplex, sensor system comprising:
a reference capacitor;
a pressure sensitive variable capacitor;
a reference current source;
a current source for supplying current which is variable with temperature;
circuitry for applying current to said reference capacitor from said reference current source until a predetermined reference voltage is reached;
circuitry for applying current to said pressure sensitive capacitor from said reference current source until a predetermined reference voltage is reached;
circuitry for alternately supplying current to said capacitors using the reference current source and using the temperature variable current source;
a source of clock pulse signals;
circuitry for determining the ratio of the number of clock pulses occurring during charging said reference capacitor to the number of clock pulses occurring during charging said pressure sensitive capacitor, to provide an indication of pressure; circuitry for counting the number of clock pulses occurring during charging the reference capacitor and the pressure sensitive capacitor using first the reference current source, and secondly using the temperature varying current source; and for using the ratio of these counts to provide an indication of temperature.

10. A multiple function, multiplex, multislope sensor system as defined in claim 9 wherein said circuitry for applying current cycles from a starting voltage level to a different level and then back to the starting level.

11. A sensor system as defined in claim 9 wherein said counting circuitry determines the number of clock pulses for charging both the reference capacitor and for charging the pressure variable capacitor using the temperature variable current source.

12. A multiple function, multiplex system as defined in claim 9 including circuitry for providing an output pulse width modulated signal representing pressure.

13. A multiple function, multiplex system as defined in claim 9 including circuitry for providing an output pulse width modulated signal representing temperature.

14. A multiple function, multiplex system as defined in claim 9 including circuitry for providing a pulse width modulated signal representing both pressure and temperature.

15. A multiple function, multiplex system as defined in claim 9 wherein said system includes switching circuitry, and comparator circuits for sensing the voltage level state of the capacitors, and actuating the switching circuitry to change mode when said reference voltage is reached.

16. A multiple function, multiplex system as defined in claim 9 wherein an integrator is coupled to receive current corresponding to the charging current to provide voltage level signals to said comparators.

17. A multiple function multiplex, sensor system comprising:
a reference capacitor;
a pressure sensitive variable capacitor;
a reference current source;
a current source for supplying current which is variable with temperature;
circuitry for applying current to said reference capacitor from said reference current source until a predetermined reference voltage is reached;
circuitry for applying current to said pressure sensitive capacitor from said reference current source until a predetermined reference voltage is reached;
circuitry for alternately supplying current to said capacitors using the reference current source and using the temperature variable current source;
a source of clock pulse signals;
circuitry for determining the ratio defining a first ratio of the number of clock pulses occurring during charging said reference capacitor to the number of clock pulses occurring during charging said pressure sensitive capacitor, to provide an indication of pressure;
circuitry for counting the number of clock pulses occurring during charging the reference capacitor and the pressure sensitive capacitor using first the reference current source, and secondly using the temperature varying current source; and for using the ratio of these counts defining a second ratio to provide an indication of temperature.
said system including circuitry for providing pulse width modulated signals including the components of first ratio.

18. A system as defined in claim 17 further including circuitry for providing pulse with modulated signals including the components of said second ratio.

19. A system as defined in claim 17 wherein said system includes microprocessor and counters for generating digital signals representing the components of said ratios.

20. A system as defined in claim 18 further comprising at lest one low pass filter coupled to receive at least one of said pulse width modulated signals.
